(19) United States
(12) Patent Application Publication
(10) Pub. No.: US 2025/0304150 A1
(43) Pub. Date: Oct. 2, 2025

(54) A Steering System and a Method of Controlling a Steering System

(71) Applicant: AGCO International GmbH, Neuhausen (CH)

(72) Inventors: Oliver Kaufmann, Marktoberdorf (DE); Gabriel Reitemann, Marktoberdorf (DE); Thomas Martin, Marktoberdorf (DE); Stefan Prestel, Marktoberdorf (DE)

(21) Appl. No.: 18/865,557

(22) PCT Filed: Apr. 5, 2023
(86) PCT No.: PCT/IB2023/053468

§ 371 Date: Nov. 13, 2024

(30) Foreign Application Priority Data
May 20, 2022 (GB) 2207467.8

(51) Int. Cl. B62D 5/093; B62D 6/00

(52) U.S. Cl. CPC B62D 5/093; B62D 6/008

(57) ABSTRACT

An electro-hydraulic steering system comprises a hydraulic steering actuator and a hydro-mechanical steering unit for actuating the hydraulic steering actuator in response to a steering demand from a steering wheel connected to the hydro-mechanical steering unit by a steering shaft. An electric motor is operative to apply a torque to the steering shaft and is controlled to provide a haptic steering torque feedback to a user through the steering wheel. The motor is controlled to provide a haptic steering torque feedback that follows a predetermined profile compensating for the effects of a spring in the hydro-mechanical steering unit which opposes movement of the steering member. The motor may be controlled to provide haptic steering torque feedback during a dead band range of movement of the steering member before the hydro-mechanical steering unit begins supplying fluid to the steering actuator.

### CROSS REFERENCE

### Field

Embodiments of the present disclosure relate generally to hydraulic steering systems and methods of controlling hydraulic steering systems.

### Background

In a steering system, rotating a steering member, such as a steering wheel, generates a steering demand indicating that a steered wheel should be turned by an angle corresponding to the direction and magnitude of rotation of the steering wheel

Hydraulic steering systems are typically used in vehicles where high steering forces may be required, for example in agricultural vehicles or other types of utility vehicles. In a hydraulic steering system, a hydraulic steering actuator is coupled to the steered wheel to cause the steered wheel to turn when actuated in response to a steering demand. The steering system includes a fluid supply arrangement, including a source of pressurized fluid and a tank, and a working port arrangement having two working ports (e.g. a left turn port and a right turn port) fluidly connected with the hydraulic steering actuator. The steering wheel is operatively connected by a steering shaft with a hydro-mechanical steering unit (otherwise referred to as a hand metering unit). The hydro-mechanical steering unit is configured to connect one of the working ports with the source of pressurized fluid and the other with the tank depending on the direction and degree of rotational movement of the steering wheel.

It is also known to provide an electro-hydraulic steering system in which a steering supply valve arrangement is connected to a controller (e.g. an electronic controller or ECU). The steering supply valve arrangement is fluidly connected with the source of pressurized fluid, the tank and the working ports and is arranged to adjust the volume of fluid provided by the hydro-mechanical steering unit to the hydraulic steering actuator. Such arrangements can be used to actively vary the steering ratio R. For example, the steering ratio R may be varied based on vehicle speed, steering wheel position, and/or steering angle. This arrangement is sometimes referred to as a superimposed hydraulic steering system. In a superimposed hydraulic steering system, the controller determines an appropriate steering ratio, based on at least one vehicle parameter, and controls the steering system to operate at that steering ratio. For example, when an agricultural vehicle such as a tractor is operating at low ground speeds, it may be desirable to operate at a low steering ratio, to enable relatively fast turns for better manoeuvrability. At high speeds, a higher steering ratio may be appropriate, in order to maintain stability. By using the steering system supply valve arrangement to increase the volume flow rate of the fluid provided by the hydro-mechanical steering unit to the steering actuator, the steering ratio R can be reduced over that provided by the hydro-mechanical steering unit itself.

The forces required to be provided by the hydraulic steering actuator will depend on the size and weight of the vehicle and the size of the tyres. Vehicle manufactures producing a range of smaller and larger vehicles provide steering systems with differently sized hydraulic steering actuators selected to meet the requirements of a particular vehicle design. Larger hydraulic steering actuators require a higher volume flow rate of fluid to provide an effective steering response compared with smaller actuators. It is usual therefor to select a hydro-mechanical steering unit capable of delivering the appropriate volume flow rate for the hydraulic steering actuator.

Hydraulic steering systems provide a different steering feel for the driver than mechanical steering systems used in conventional automotive vehicles, such as motor cars. In a mechanical steering system, forces from the steered wheels are transmitted back to the driver through the steering wheel as a haptic steering torque feedback. Even in a hydraulic power assisted system, forces from the steered wheels are transmitted through to the steering wheel. In a hydraulic steering system, the steering wheel is largely isolated form the forces at the steered wheels.

### BRIEF SUMMARY

Aspects of the invention relate to electro-hydraulic steering systems, methods of operating electro-hydraulic steering systems, vehicles, which may be utility vehicles such as agricultural vehicles, and to methods of operating vehicles, which may be utility vehicles such as agricultural vehicles.

According to an aspect of the invention, there is provided an electro-hydraulic steering system for a vehicle comprising a hydraulic steering actuator and a hydro-mechanical steering unit for actuating the hydraulic steering actuator in response to a steering demand from a steering member connected to the hydro-mechanical steering unit by a steering shaft, the system including an electric motor for applying a torque to the steering shaft and an electronic controller for controlling actuation of the electric motor, the controller configured to control actuation of the electric motor to provide a haptic steering torque feedback to a user through the steering member.

In embodiments, the controller is configured to control the electric motor to provide haptic steering torque feedback during a dead band range of movement of the steering member before the hydro-mechanical steering unit begins supplying fluid to the steering actuator.

In embodiments, the controller is configured to control the electric motor to provide a haptic steering torque feedback sensed by the user that follows a predetermined profile over a range of movement of the steering member from an initial position, compensating for the effects of a resilient biasing arrangement in the hydro-mechanical steering unit which opposes movement of the steering member.

According to a further aspect of the invention, there is provided an electro-hydraulic steering system for a vehicle comprising:
a hydraulic steering actuator for turning a steered wheel through a rotation angle;
a fluid supply arrangement including a source of pressurized fluid and a tank;
a working port arrangement having two working ports fluidly connected with the hydraulic steering actuator;
a hydro-mechanical steering unit fluidly connected between the fluid supply arrangement and the working port arrangement and configured to connect one of the working ports with the source of pressurized fluid and the other with the tank in dependence on a steering demand;
a steering member connected with the hydro-mechanical steering unit by a steering shaft, the steering member movable by a user to rotate the steering shaft to generate a steering demand;
a steering member sensor connected to a controller for detecting the position and/or movement of the steering member;
a steering supply valve arrangement fluidly connected with the source of pressurized fluid, the tank and the working ports, the steering supply valve arrangement connected with the controller;
an electric motor operative to apply a torque to rotate the steering shaft when actuated, the electric motor operatively connected to the controller;
wherein the controller is configured upon detection of movement of the steering member to provide a control output to the actuate the steering supply valve arrangement to supply fluid to one of the working ports of the working port arrangement in dependence on the direction of movement of the steering member at least during movement of the steering member from an initial position through a dead band range of movement in which the hydro-mechanical steering unit does not supply fluid to said one of the working ports;
wherein the controller is configured such that when the steering member is moved from the initial position through at least part of the dead band range of movement, the controller is configured to provide a control output tau actuate the electric motor to apply a torque to rotate the steering shaft in a direction which opposes the direction of rotation applied to the steering shaft by the user.

Using the steering supply valve arrangement to supply fluid to the steering actuator within the dead band enables the steering system to respond to a steering demand more quickly. However, during this dead band, the steering system does not inherently provide any significant resistance to the steering member being turned. Thus using the electric motor to apply a torque to rotate the steering shaft in a direction which opposes the direction of rotation applied to the steering shaft by the user, provides the user with a haptic steering torque feedback so that the driving experience is improved.

According to a further aspect of the invention, there is provided an electro-hydraulic steering system for a vehicle comprising:
a hydraulic steering actuator for turning a steered wheel through a rotation angle;
a fluid supply arrangement including a source of pressurized fluid and a tank;
a working port arrangement having two working ports fluidly connected with the hydraulic steering actuator;
a hydro-mechanical steering unit fluidly connected between the fluid supply arrangement and the working port arrangement and configured to connect one of the working ports with the source of pressurized fluid and the other with the tank in dependence on a steering demand;
a steering member connected with the hydro-mechanical steering unit by a steering shaft, the steering member movable by a user to rotate the steering shaft to generate a steering demand;
a steering member sensor connected to a controller for detecting the position and/or movement of the steering member;
a steering supply valve arrangement fluidly connected with the source of pressurized fluid, the tank and the working ports, the steering supply valve arrangement connected with the controller;
an electric motor operative to apply a torque to rotate the steering shaft when actuated, the electric motor operatively connected to the controller;
wherein the controller is configured modify a haptic steering torque feedback sensed by the user through the steering member by providing a control output to control actuation of the electric motor to apply torque to rotate the steering shaft, wherein the controller is configured to control actuation of the electric motor in dependence on at least one parameter indicative of an operating condition of the vehicle such that the haptic steering torque feedback sensed by the user follows a predetermined profile over a range of movement of the steering member from an initial position.

This is advantageous as the electric motor can be used to control the haptic steering torque feedback experienced by the user so as to provide a haptic steering torque feedback profile which more closely matches the haptic steering torque feedback profile of a conventional automotive vehicle having a mechanical steering system or a fluid power assisted mechanical steering system. The arrangement can also be used to deliver a similar driver experience across a range of vehicles of differing sizes.

In some embodiments, controller is configured to control actuation of the electric motor to modify the haptic steering torque feedback sensed by the user in dependence on at least one of the following:
a steering angle of the steered wheel;
a steering angle of the steering member;
a steering torque applied by a user to the steering member;
a ground speed of the vehicle;
fluid pressure differential between the chambers of the steering actuator;
speed of movement of the steering member.

In some embodiments, the controller is configured such that when the steering member is moved from an initial position through at least part of a dead band range of movement in which the hydro-mechanical steering unit does not supply fluid to said one working port, the controller actuates the electric motor to apply a torque to rotate the steering shaft in a direction which opposes the direction of rotation applied to the steering shaft by the user.

In some embodiments, the controller is configured to actuate the electric motor to apply an increasing level of torque rotating the steering shaft in a direction which opposes the direction of rotation applied by the user through the steering member during a first phase of movement of the steering member from an initial position to an intermediate position between the initial position and the end of the dead band range of movement and to apply a decreasing level of torque rotating the steering shaft in the same direction during a second phase of the movement of the steering member beyond the intermediate position within the dead band range of movement.

In some embodiments, the hydro-mechanical steering unit comprises a resilient biasing arrangement which biases the unit to a neutral position in which no fluid is supplied to the working port arrangement, the hydro-mechanical steering unit being movable to a first working position in which a first of the working ports is connected with the pressurized fluid supply and a second of the working ports is connected with the tank in response to movement of the steering member from an initial position in a first rotary direction and is movable to a second working position in which the first of the working ports is connected with the tank and the second of the working ports is connected with the source of pressurized fluid in response to movement of the steering member from an initial position in a second rotary direction opposite to the first, the resilient biasing arrangement generating a torque on the steering shaft which opposes the direction of rotation of the steering member applied by the user when the hydro-mechanical steering unit is moved from the neutral position to either of the first and second working positions, wherein the resilient biasing arrangement generates substantially no torque during a first range of movement of the steering member from the initial position, the resilient biasing arrangement generating an increasing level of torque on the steering shaft during a transitional range of rotational movement of the steering member following the first range of movement, and the resilient biasing arrangement generating a substantially steady level of torque during movement of the steering member beyond the transitional range; wherein the controller is configured to control actuation of the motor so that during the transitional range of movement of the steering member, the torque applied by the electric motor to rotate the steering shaft in a direction which opposes the rotational movement of the steering member by the user is reduced as a function of the increasing torque applied to the steering shaft by the resilient biasing arrangement.

In some embodiments, the controller is configured to control actuation of the electric motor so as to modulate the degree and direction of the torque applied by the electric motor to the steering shaft as the steering member is moved from an initial position during a steering manoeuvre as to maintain the predefined profile of haptic steering torque feedback compensating for any torque applied to the steering shaft resulting from operation of the hydro-mechanical steering unit, including for example torque applied to the steering shaft by a resilient biasing arrangement of the hydro-mechanical steering unit.

According to an aspect of the invention, there is provided a vehicle having an electro-hydraulic steering system according to any of the aspects of the invention set out above. The vehicle may be a utility vehicle and may be an agricultural vehicle, such as a tractor. The term vehicle should be understood as encompassing self-propelled machines such as harvesters and the like.

Methods corresponding to the various aspects of the invention set out above may also be claimed.

According to an aspect of the invention, there is provided a method of operating an electro-hydraulic steering system for a vehicle, the system comprising a hydraulic steering actuator and a hydro-mechanical steering unit for actuating the hydraulic steering actuator in response to a steering demand from a steering member connected to the hydro-mechanical steering unit by a steering shaft, the system including an electric motor for applying a torque to the steering shaft and an electronic controller for controlling actuation of the electric motor; the method comprising controlling actuation of the electric motor to provide a haptic steering torque feedback to a user through the steering member.

In embodiments, the method comprises controlling actuation of the electric motor to provide haptic steering torque feedback during a dead band range of movement of the steering member before the hydro-mechanical steering unit begins supplying fluid to the steering actuator.

In embodiments, the method comprises controlling actuation of the electric motor to provide a haptic steering torque feedback sensed by the user that follows a predetermined profile over a range of movement of the steering member from an initial position, compensating for the effects of a resilient biasing arrangement in the hydro-mechanical steering unit which opposes movement of the steering member.

According to a further aspect of the invention, there is provided a method of operating an electro-hydraulic steering system for a vehicle, the system comprising:
a hydraulic steering actuator for turning a steered wheel through a rotation angle;
a fluid supply arrangement including a source of pressurized fluid and a tank;
a working port arrangement having two working ports fluidly connected with the hydraulic steering actuator;
a hydro-mechanical steering unit fluidly connected between the fluid supply arrangement and the working port arrangement and configured to connect one of the working ports with the source of pressurized fluid and the other with the tank in dependence on a steering demand;
a steering member connected with the hydro-mechanical steering unit by a steering shaft, the steering member movable by a user to rotate the steering shaft to generate a steering demand;
a steering member sensor connected to a controller for detecting the position and/or movement of the steering member;
a steering supply valve arrangement fluidly connected with the source of pressurized fluid, the tank and the working ports, the steering supply valve arrangement connected with the controller;
an electric motor operative to apply a torque to rotate the steering shaft when actuated, the electric motor operatively connected to the controller;
the method comprising:
detecting at least an initial movement of the steering member and in response to said detection actuating the steering supply valve arrangement to supply fluid to one of the working ports of the working port arrangement in dependence on the direction of movement of the steering member at least during movement of the steering member from an initial position through a dead band range of movement in which the hydro-mechanical steering unit does not supply fluid to said one of the working ports;
the method also comprising actuating the electric motor to apply a torque to rotate the steering shaft in a direction which opposes the direction of rotation applied to the steering shaft by the user when the steering member is moved from the initial position through at least part of the dead band range of movement.

According to a further aspect of the invention, there is provided a method of operating an electro-hydraulic steering system for a vehicle, the system comprising:
a hydraulic steering actuator for turning a steered wheel through a rotation angle;
a fluid supply arrangement including a source of pressurized fluid and a tank;
a working port arrangement having two working ports fluidly connected with the hydraulic steering actuator;
a hydro-mechanical steering unit fluidly connected between the fluid supply arrangement and the working port arrangement and configured to connect one of the working ports with the source of pressurized fluid and the other with the tank in dependence on a steering demand;
a steering member connected with the hydro-mechanical steering unit by a steering shaft, the steering member movable by a user to rotate the steering shaft to generate a steering demand;
a steering member sensor connected to a controller for detecting the position and/or movement of the steering member;
a steering supply valve arrangement fluidly connected with the source of pressurized fluid, the tank and the working ports, the steering supply valve arrangement connected with the controller;
an electric motor operative to apply a torque to rotate the steering shaft when actuated, the electric motor operatively connected to the controller;
the method comprising modifying a haptic steering torque feedback sensed by the user through the steering member by actuating the electric motor to apply torque to rotate the steering shaft, actuation of the electric motor being carried out in dependence on at least one parameter indicative of an operating condition of the vehicle such that the haptic steering torque feedback sensed by the user follows a predetermined profile over a range of movement of the steering member from an initial position.

In some embodiments, the method comprises controlling the electric motor to modify the haptic steering torque feedback sensed by the user in dependence on at least one of the following:
a steering angle of the steered wheel;
a steering angle of the steering member;
a steering torque applied by a user to the steering member;
a ground speed of the vehicle;
fluid pressure differential between the chambers of the steering actuator;
speed of movement of the steering member.

In some embodiments, the method comprises controlling actuation of the electric motor to apply a torque to rotate the steering shaft in a direction which opposes the direction of rotation applied to the steering shaft by the user when the steering member is moved from an initial position through at least part of a dead band range of movement in which the hydro-mechanical steering unit does not supply fluid to said one working port.

In some embodiments, the method comprises controlling actuation of the electric motor to apply an increasing level of torque rotating the steering shaft in a direction which opposes the direction of rotation applied by the user through the steering member during a first phase of movement of the steering member from an initial position to an intermediate position between the initial position and the end of the dead band range of movement and to apply a decreasing level of torque rotating the steering shaft in the same direction during a second phase of the movement of the steering member beyond the intermediate position within the dead band range of movement.

In some embodiments, the hydro-mechanical steering unit comprises a resilient biasing arrangement which biases the unit to a neutral position in which no fluid is supplied to the working port arrangement, the hydro-mechanical steering unit being movable to a first working position in which a first of the working ports is connected with the pressurized fluid supply and a second of the working ports is connected with the tank in response to movement of the steering member from an initial position in a first rotary direction and is movable to a second working position in which the first of the working ports is connected with the tank and the second of the working ports is connected with the source of pressurized fluid in response to movement of the steering member from an initial position in a second rotary direction opposite to the first, the resilient biasing arrangement generating a torque on the steering shaft which opposes the direction of rotation of the steering member applied by the user when the hydro-mechanical steering unit is moved from the neutral position to either of the first and second working positions, wherein the resilient biasing arrangement generates substantially no torque during a first range of movement of the steering member from the initial position, the resilient biasing arrangement generating an increasing level of torque on the steering shaft during a transitional range of rotational movement of the steering member following the first range of movement, and the resilient biasing arrangement generating a substantially steady level of torque during movement of the steering member beyond the transitional range; wherein the method comprises controlling actuation of the electric motor so that during the transitional range of movement of the steering member, the torque applied by the electric motor to rotate the steering shaft in a direction which opposes the rotational movement of the steering member by the user is reduced as a function of the increasing torque applied to the steering shaft by the resilient biasing arrangement.

In some embodiments, the method comprises controlling actuation of the electric motor so as to modulate the degree and direction of the torque applied by the electric motor to the steering shaft as the steering member is moved from an initial position during a steering manoeuvre as to maintain the predefined profile of haptic steering torque feedback compensating for any torque applied to the steering shaft resulting from operation of the hydro-mechanical steering unit, including for example torque applied to the steering shaft by a resilient biasing arrangement of the hydro-mechanical steering unit.

According to an aspect of the invention, there is provided a computer program product comprising instructions which, when the program is executed by a computer, cause the computer to carry out one or more the above-described methods.

According to an aspect of the invention, there is provided a computer-readable medium having stored thereon the above-described computer program product.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention will now be described, by way of example only, with reference to the accompanying drawings, in which:

FIG. 1 is a schematic diagram illustrating part of a vehicle having an embodiment of an electro-hydraulic steering system in accordance with an aspect of the invention;

FIG. 2 schematically illustrates volume flow rates of fluid provided by a hydro-mechanical steering unit and a steering supply valve arrangement forming part of the steering system of FIG. 1 for two different ranges of vehicle;

FIGS. 3 and 4 schematically illustrate volume flow rates of fluid delivered by a hydro-mechanical steering unit and a steering supply valve arrangement forming part of the steering system of FIG. 1, showing how the fluid flows rates change as a steering wheel is rotated from an initial position;

FIG. 5 illustrates an arrangement for providing a haptic steering torque feedback to user of the steering system of FIG. 1;

FIG. 6 illustrates how the level of haptic steering torque feedback may be varied in dependence on the pressure differential between first and second chambers in a hydraulic steering actuator of the steering system of FIG. 1;

FIG. 7 illustrates how the level of haptic steering torque feedback may be varied in dependence on the speed of the vehicle;

FIG. 8 illustrates how the level of haptic steering torque feedback may be varied in dependence on a changes in the steering angle from any given starting position;

FIG. 9 illustrates how the level of haptic steering torque feedback may be varied in dependence on the speed of rotation of a steering wheel of the steering system of FIG. 1 and/or in dependence on a torque applied to the steering wheel by a user; and

FIG. 10 illustrates a number of different haptic steering torque feedback profiles.

### DETAILED DESCRIPTION

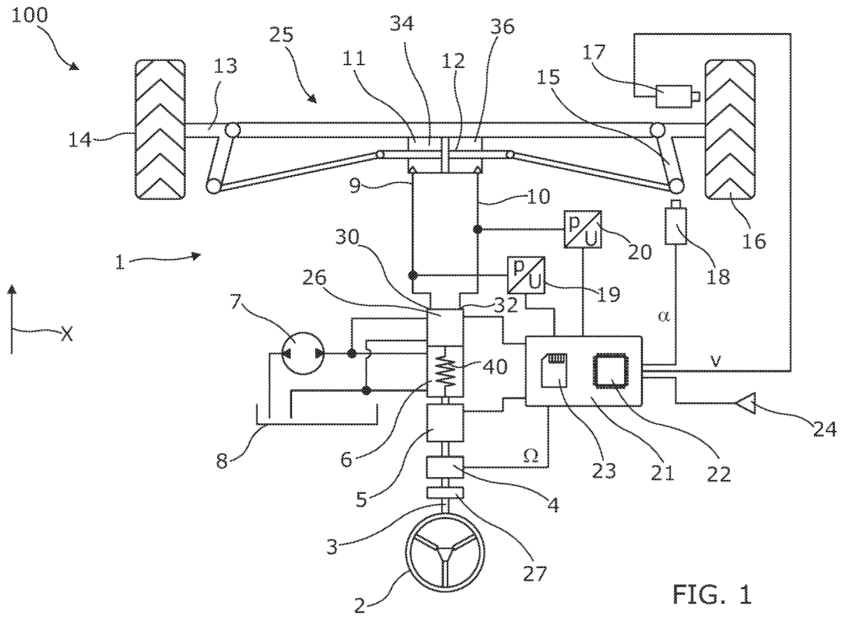

According to an example of an aspect of the invention there is provided an electro-hydraulic steering system 1 for a vehicle 100 comprising at least one steered wheel (here the steered wheels 14, 16) as shown in FIG. 1. The steering system 1 comprises a steering member 2, which may be in the form of steering wheel, for setting a desired steering angle (i.e. angular position) of the steered wheels 14, 16 and a hydraulic steering actuator 11 operably coupled to the steered wheels 14, 16 to turn the steered wheels 14, 16 when actuated in response to a steering demand from the steering wheel 2.

The steering wheel 2 is coupled to a steering shaft 3 which is arranged to transmit rotational movement of the steering wheel 2 to a hydro-mechanical steering unit 6 (sometimes also referred to as a hand metering unit). In a non-limiting example, the hydro-mechanical steering unit 6 may be an Orbitrol® hydrostatic valve, available from Danfoss Power Solutions APS.

The hydro-mechanical steering unit 6 is hydraulically connected to a fluid supply arrangement including a source of pressurized fluid 7 and a tank or reservoir 8. The source of pressurized fluid 7 may take the form of a form of a pump, which is arranged to pump hydraulic fluid from the tank 8 to the hydro-mechanical steering unit 6. The hydro-mechanical steering unit 6 is also hydraulically connected to the hydraulic steering actuator through a working port arrangement including a first working port 30 and a second working port 32, and by means of a first hydraulic line 9 connected with the first working port 30 and a second hydraulic line 10 connected with the second working port 32. The hydraulic steering actuator 11 in this embodiment is a double acting hydraulic cylinder housing a piston 12 dividing the cylinder into a first chamber 34 and a second chamber 36. The first hydraulic line 9 is fluidly connected with the first chamber 34 and the second hydraulic line 10 is fluidly connected with the second chamber 36. The piston 12 is arranged to move axially within the steering cylinder 11 in response to a pressure differential Ap between the first and second chambers 34, 36 and is coupled to a steering arrangement 25 of the vehicle 100. Movement of the piston 12 in response to a change in pressure in the first and second chambers 34, 36 exerts a steering force on the steering arrangement 25 thereby turning the steered wheels 14, 16. Pressure sensors 19, 20 are arranged to sense the pressure of the hydraulic fluid in the hydraulic lines 9, 10 (and hence the pressure in the respective chambers 34, 36).

The first working port 30 and the first chamber 34 may be designated a left port (left turn port) and a left chamber (left turn chamber) respectively as this working port 30 and chamber 34 are connected to the source of pressurized fluid to cause the vehicle to steer to the left when travelling forwards. Similarly, the second working port 32 and the second chamber 36 may be designated a right port (right turn port) and a right chamber (right turn chamber) respectively as this working port 32 and chamber 36 are connected to the source of pressurized fluid to cause the vehicle to steer to the right when travelling forwards. It will be appreciated that according to this definition and depending on the steering arrangement, left turn and right turn chambers might not be arranged to the left and right of each other.

In use, the steering wheel 2 is rotated by a user to generate a steering demand for steering the steered wheels 14 and 16. The rotational movement of the steering wheel 2 is transmitted to the hydro-mechanical steering unit 6 by the steering shaft 3. Depending on the direction of rotation of the steering wheel 2, the hydro-mechanical steering unit 6 is operative in response to a steering demand to connect one of the working ports 30, 32 to the source of pressurized fluid 7 and the other working port 30, 32 to tank 8. In the embodiment as illustrated, rotation of the steering wheel 2 indicating that a left turn is required causes the hydro-mechanical steering unit 6 to connect to the first working port 30 and the first hydraulic line 9 to the source of pressurized fluid 7 and the second working port 32 and second hydraulic line 10 to the tank 8. As a result, the fluid pressure in the first chamber 34 is increased above that in the second chamber 36 causing the piston to move to the right as viewed in FIG. 1. This in turn causes the steered wheels 14, 16 to turn to the left, as viewed and may cause the vehicle effect a left turn when travelling in a forward direction as indicated by arrow X if the wheels 14, 16 are initially in a straight ahead position. Conversely, in response to rotation of the steering wheel 2 indicative of a demand for a right turn, the hydro-mechanical steering unit 6 is operative to connect the second working port 32 and the second hydraulic line 10 to the source of pressurized fluid and the first working port 30 and the first hydraulic line 9 to the tank 8. This results in the fluid pressure in the second chamber 36 increasing above that in the first chamber 34 causing the piston 12 to move to the left as viewed in FIG. 1. This in turn causes the steered wheels 14, 16 to turn to the right, as viewed, so that the vehicle effects a right hand turn when travelling in the forward direction if the wheels are initially in the straight ahead position.

It will be appreciated that steering actuator 11 and steering arrangement 25 can be configured in various different ways and that the hydro-mechanical steering unit 6 can be connected to the steering actuator 11 in any appropriate way that results in turning movement of the steered wheels 14, 16 in the desired direction as indicated by the direction of rotation of the steering wheel 2. For example, rather than a single, double acting hydraulic cylinder, the steering actuator 11 may include a pair of double acting hydraulic cylinders operatively connected to the steered wheels 14, 16 such that extension of a first one of the cylinders and retraction of a second one of the cylinders causes the steered wheels to turn in one direction, whilst extension of the second cylinder and retraction of the first cylinder causes the steered wheels to turn in the opposite direction. In this case, the working ports 30, 32 are connected to the chambers in the hydraulic cylinders in a crossover manner as is known in the art.

The hydro-mechanical steering unit 6 comprises a resilient biasing arrangement indicated schematically at 40, typically a spring arrangement, which biases the unit to a neutral position in which no fluid is supplied to the working ports 30, 32. In response to rotation of the steering shaft 3 in a first rotary direction, the hydro-mechanical steering unit is moved from the neutral position to a first working position in which a first of the working ports 30, 32 is connected with the pressurized fluid supply 7 and a second of the working ports 30, 32 is connected with the tank 8. In response to rotation of the steering shaft 3 in a second rotary direction opposite to the first, the hydro-mechanical steering unit 6 is moved to a second working position in which the first of the working ports 30, 32 is connected with the tank 8 and the second of the working ports 30, 32 is connected with the source of pressurized fluid 7. When the steering shaft 3 is rotated to move the hydro-mechanical steering unit to one of the first and second working positions, the resilient biasing arrangement applies a restoring force tending to move the hydro-mechanical steering unit back to the neutral position. This results in a reactive torque being applied to the steering shaft 3 which opposes the direction of rotation of the steering shaft 3 applied by a user via the steering wheel 2. When the steering wheel 2 is first moved from any initial position, the resilient biasing arrangement 40 generates substantially no torque in a first range of movement of the steering wheel 2. Following the first range of movement, the resilient biasing arrangement 40 generates an increasing level of reactive torque on the steering shaft 3 over a transitional range of rotational movement of the steering member. At the end of the transitional range, the resilient biasing arrangement is producing its maximum level of reactive torque which remains substantially constant for any continued movement of the steering wheel 2 beyond the transitional range. Should the user stop rotating the steering wheel 2, the resilient biasing arrangement 40 moves the hydro-mechanical steering unit back to the neutral position so that no further fluid is supplied to the steering actuator 11 by the hydro-mechanical steering unit and the steering actuator 11 is held in position until the steering wheel 2 is again turned.

In a typical arrangement, the hydro-mechanical steering unit 6 has a rotary spool (not shown) located within a sleeve (not shown), the valve spool and the sleeve having complementary ports. When the steering wheel 2 is rotated, the steering shaft 3 turns the valve spool within the sleeve to move from the neutral position to one of the working positions against the action of a hydro-mechanical steering unit spring 40 biasing the valve spool back to the neutral position relative to the valve sleeve. However, the hydro-mechanical steering unit 6 can take other forms.

As used herein in relation to movement of the steering wheel to generate a steering demand, reference to “an initial position of the steering wheel” should be understood as referring to a stationary position of the steering wheel 2 at which the hydro-mechanical steering unit 6 is in the neutral position. Movement of the steering wheel 2 away from an initial position results in the hydro-mechanical steering unit 6 being moved from the neutral position towards one of the working positions. The term “an initial position of the steering wheel” should not be interpreted referring to an absolute position of the steering wheel 2. For example, if the steering wheel 2 is in a straight ahead position and is rotated to the left by 10 degrees and then held in that position, the straight ahead position would be an initial position of the steering wheel 2 for this first steering wheel movement. However, if the steering wheel is held at the 10 degree left position and the hydro-mechanical steering unit returns to the neutral position, the 10 degree left position will be an initial position of the steering wheel for a subsequent movement of the steering wheel away from the 10 degree left position.

Typically there will be some free play or backlash in the mechanical connection between the steering wheel 2 and the hydro-mechanical steering unit 6. Furthermore, a hydro-mechanical steering unit 6 typically has a hydraulic dead band within which no fluid is supplied by the hydro-mechanical steering unit to the relevant working port 30, 32 on movement of the hydro-mechanical steering unit 6 from the neutral position towards one of the working positions. As a result, when the steering wheel 2 is rotated from an initial position, the hydro-mechanical steering unit 6 will not begin supplying fluid to the relevant working port 30, 32 and the steering actuator 11 until the steering wheel 2 has been rotated though an initial range of movement, which will be referred to as a “dead band range of movement”. The transitional range of rotational movement of the steering wheel 2 over which the torque applied by the hydro-mechanical steering unit spring 40 increases will typically begin within the dead band range of movement of the steering wheel 2 but may not end until after the dead band range of movement.

A steering supply valve arrangement 26 is hydraulically connected to the source of pressurized fluid 7, the tank 8 and the first and second working ports 30, 32. The steering supply valve arrangement 26 is an electronically controllable valve arrangement operable to selectively connect either one of the working ports 30, 32 to the source of pressurized fluid 7 and the other of the working ports 30, 32 to the tank 8. The steering supply valve arrangement 26 may include one or more solenoid valves and may be a proportional valve arrangement. The steering supply valve arrangement 26 is able to actuate the steering actuator 11 bypassing the hydro-mechanical steering unit 6 (and hydro-mechanical steering unit flow) and so may be referred to as a steering supply bypass valve arrangement The steering supply valve arrangement 26 can be used to actuate the steering actuator 11 independently of the hydro-mechanical steering unit 6 but can also be used in combination with the hydro-mechanical steering unit 6 to amplify the volume flow rate of the fluid provided by the hydro-mechanical steering unit 6 to the steering actuator.

The steering supply valve arrangement 26 may be provided separately from the hydro-mechanical steering unit 6 or it may integrated with the hydro-mechanical steering unit 6 as a combined unit as illustrated. When the steering supply valve arrangement 26 and hydro-mechanical steering unit 6 are combined in a single unit, they may share fluid connections to the sources of pressurized fluid 7 and the tank 8 and the working ports. An example of a suitable combined hydro-mechanical steering unit 6 and steering supply valve arrangement 26 is the Danfoss OSPEC 400 LSRM available from Danfoss Power Solutions APS, Denmark.

The steering system 1 may be part of an open centre or a closed centre hydraulic system.

As shown in FIG. 1, the steering system 1 may also comprise an electric motor 5 arranged to selectively apply a torque to rotate the steering shaft 3 in either rotational direction of the steering shaft 3. Accordingly, the electric motor can rotate the steering shaft 3 either to the left or to the right, that is to say in clockwise and anticlockwise directions where a clockwise movement corresponds to movement of the steering wheel 2 to the right and anticlockwise movement corresponds to movement of the steering wheel 2 to the left as viewed in FIG. 1. The electric motor 5 is operable to modify a haptic steering torque (force) feedback sensed by the user through the steering wheel 2 by applying torque to rotate the steering shaft 3. In other words, the electric motor 5 is operative to adjust the feel of the steering to a user by modifying the torque which opposes rotational movement of the steering wheel 2 by a user to effect a steering manoeuvre.

The steering system 1 has a control unit 21 (e.g. an electronic control unit ECU) comprising a controller or processor 22 and memory 23. The controller 22 is configured to receive and process sensor signals/data, which may include any one or more of the following: signals/data representative of an angular position of the steering wheel 2, an angular position of the steered wheel 14, 16, vehicle speed v (i.e. speed over the ground), fluid pressure differential Ap between the first and second chambers 34, 36 in the steering actuator, steering torque applied by a user to the steering wheel 2, and speed of movement of the steering wheel 2.

In one embodiment, the control unit 21 is an ECU comprising one or more controllers or processors 22, input/output (I/O) interface(s), and the memory 23, all coupled to one or more data busses. The memory 23 may include any one or a combination of volatile memory elements (e.g., random-access memory RAM, such as DRAM, and SRAM, etc.) and non-volatile memory elements (e.g., ROM, hard drive, tape, CDROM, etc.). The memory 23 may store a native operating system, one or more native applications, emulation systems, or emulated applications for any of a variety of operating systems and/or emulated hardware platforms, emulated operating systems, etc. In one embodiment the memory comprises an operating system and software for carrying out various of the control strategies described herein, such as those for controlling actuation of the steering supply valve arrangement 26 and the electric motor 5. It should be appreciated by one having ordinary skill in the art that in some embodiments, additional or fewer software modules (e.g., combined functionality) may be employed in the memory 23 or additional memory. In some embodiments, a separate storage device may be coupled to the data bus, such as a persistent memory (e.g., optical, magnetic, and/or semiconductor memory and associated drives).

The controller 22 may be embodied as a custom-made or commercially available processor, a central processing unit (CPU) or an auxiliary processor among several processors, a semiconductor based microprocessor (in the form of a microchip), a macro processor, one or more application specific integrated circuits (ASICs), a plurality of suitably configured digital logic gates, and/or other well-known electrical configurations comprising discrete elements both individually and in various combinations to coordinate the overall operation of the control unit 21.

The steering system 1 includes various sensors which provide signals/data to the controller 21. These include a speed sensor 17 which is arranged to sense the speed of the vehicle (e.g. the speed of the vehicle over the ground). The steering system 1 also comprises a steering wheel sensor 4 and a wheel angle sensor 18. The steering wheel sensor 4 is arranged to continuously sense the angular position of the steering wheel 2 (and hence movement and/or the angular speed of the steering wheel), and to send data representing the steering wheel position and speed of movement to the control unit 21. The steering wheel sensor 4 is mounted at a location of minimal free play between the sensor 4 and the steering wheel 2 so that the sensor 4 can be used to detect the position and/or movement of the steering wheel 2 with an acceptable level of accuracy. The steering wheel sensor 4 may be configured to detect the angular position and/or rotational movement of the steering shaft 3 as a means of monitoring the angular position and/or rotational movement of the steering wheel 2. The wheel angle sensor 18 continuously senses an angular position of at least one of the steered wheels 14, 16, and sends the sensed information to the control unit 21. The pressure sensors 19, 20 are also configured to send signal/data representative of the fluid pressure in the first and second hydraulic lines 9, 10 and the first and second chamber 34, 36 in the hydraulic steering actuator 11. The signals/data from the sensors can be stored in the memory 23. A sensor 27 for determining the torque applied by a user to the steering wheel 2 may also be provided and configured to send a signal/data representative of the applied torque to the controller 21.

The steering system 1 is designed to operate up to a maximum operating volume flow rate Qop of fluid to the hydraulic steering actuator 11 in order to provide an effective steering function under normal operating conditions. The maximum operating volume flow rate Qop may not be the maximum volume flow rate Qmax that the system is capable of handling, which will usually be set higher that the maximum operating volume flow rate Qop for safety reasons. The maximum operating volume flow rate Qop will be referred to as a first threshold value of volume flow rate. However, to ensure that the steering system 1 can be operated in an emergency mode, say in the event the normal supply of pressurized fluid fails, the steering system 1 may be designed to be operable at least in a limited fashion to provide some steering functionality provided the volume flow rate of fluid to the steering actuator 11 is above a minimum value Qe, which is less than the maximum operating volume flow rate Qop. The minimum volume flow rate Qe required to provide an emergency steering function will be referred to as a second threshold value Qe. The actual values for the maximum operating volume flow rate Qop and the minimum emergency steering volume flow rate Qe are dependent on the specific properties of the steering system 1 and the vehicle, including parameters such as the size of the steering actuator 11, the weight of the vehicle 100, and the size of the steered wheels 14, 16, for example, and may be subject to the steering system meeting legal requirements in some jurisdictions. However, the person skilled in the art will be able to determine appropriate values for the maximum operating volume flow rate Qop and the minimum emergency steering volume flow rate Qe for any given application.

In an embodiment, the hydro-mechanical steering unit 6 in the steering system 1 is calibrated or specified so that it is capable of delivering a maximum flow rate Qorbmax which is less than the maximum operating volume flow rate Qop but higher than the minimum emergency steering volume flow rate Qe. In other words, the hydro-mechanical steering unit 6 is only capable of delivering a maximum volume flow rate Qorbmax which is less than the first threshold value but higher than the second threshold value. To enable the steering system 1 to operate effectively under normal operating conditions, the controller 21 is configured to actuate the steering supply valve arrangement 26 in accordance with one or more management programs or algorithms to increase the volume flow rate of fluid provided to the hydraulic steering actuator 11 up to the maximum operating volume flow rate Qop, where this is required to meet a steering demand. Thus the fluid flow Qs from the steering supply valve arrangement 26 is combined with the fluid flow Qorb from the hydro-mechanical steering unit 6 to provide a combined fluid flow Qsum delivered through the working port arrangement 30, 32 to the steering actuator 11. In the event that the normal fluid supply to the steering system 1, the controller 21 or the steering supply valve arrangement 26 should fail, the hydro-mechanical steering unit 6 is still capable of delivering a volume flow rate of fluid Qorbmax, which is sufficient to provide an emergency steering function. This is advantageous as it enables a hydro-mechanical steering unit 6 to be used in a steering system 1 which has a smaller volume flow rate capacity than is required to meet the demands of the steering system 1 under normal operating conditions with the shortfall being compensated for by fluid flow Qs from the steering supply valve arrangement 26. This enables a lower cost hydro-mechanical steering unit 6 to be used with no loss of steering performance or safety.

Furthermore, this arrangement enables a common hydro-mechanical steering unit 6 to be used in steering systems 1 across a range of vehicles, even where at least some of the steering systems are designed to operate at different maximum operating volume flow rates Qop. Provided the hydro-mechanical steering unit 6 is capable of delivering a maximum volume flow rate Qorbmax which is higher than the required minimum emergency steering volume flow rates Qe (the second threshold value) for each of the various steering systems/vehicles in the range or ranges, the controller 21 can be configured to regulate actuation of the steering supply valve 26 to ensure that required maximum operating volume flow rate Qop at the steering actuator can be met for each steering system/vehicle. This enables common components (e.g. the hydro-mechanical steering unit and steering supply valve arrangement 26) to be used across a range of vehicles with only changes to the controller algorithm required to adapt the maximum operating volume flow rate Qop of the fluid delivered to the steering actuator 11 to the requirements of any given steering system/vehicle. This leads to a reduction in parts that have to be held by a vehicle manufacturer thus saving manufacturing costs.

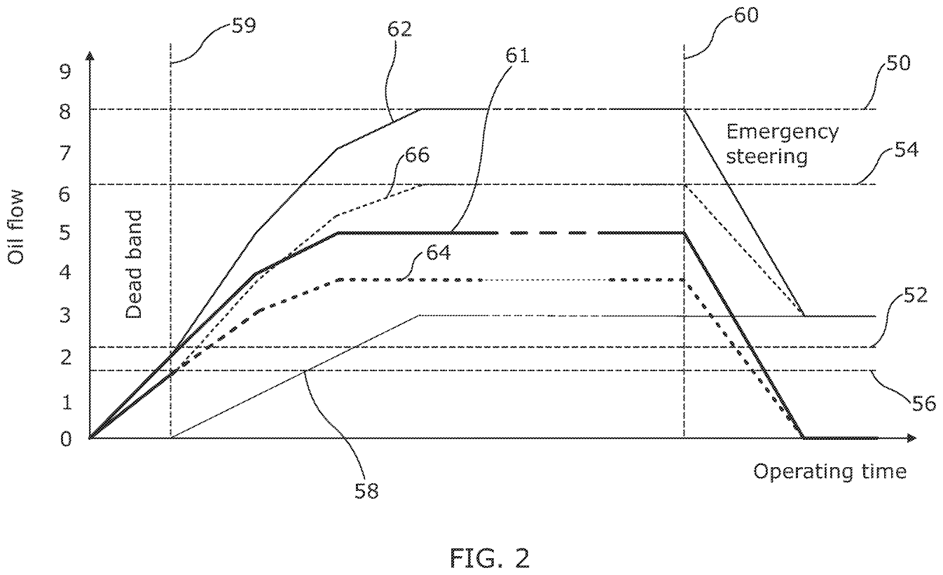

This arrangement is illustrated schematically in FIG. 2, which includes a number of graphs illustrating volume fluid flow rates from a hydro-mechanical steering unit 6 and a steering supply valve arrangement 26 for two different tractor ranges which use a commonly specified hydro-mechanical steering unit 6. FIG. 2 illustrates the volume fluid flow rates under normal operating conditions and under emergency steering conditions. Lines 50 and 52 indicate respectively the first threshold value for the maximum operating volume flow rate Qop1 and the second threshold value for the minimum emergency steering volume flow rate Qe1 of a first range of tractors. Lines 54 and 56 indicate respectively the first threshold value for the maximum operating volume flow rate Qop2 and the second threshold volume for the minimum emergency steering volume flow rate Qe2 of a second range of tractors smaller than the first range.

Both ranges of tractors use a commonly specified hydro-mechanical steering unit 6. Graph 58 indicates the volume flow rate Qorb provided by the hydro-mechanical steering unit 6 during a steering actuation. In an initial dead band region indicated by the block on the left, ending at line 59, there is no fluid flow from the hydro-mechanical steering unit 6. After the dead band, the fluid flow from the hydro-mechanical steering unit increases up to a maximum value Qorbmax. It will be noted that the maximum volume flow Qorbmax provided by the hydro-mechanical steering unit 6 is higher than the second threshold values 52, 56 for both the first and second ranges of tractor. The block on the right hand side of FIG. 2 beginning at line 60 illustrates an emergency steering mode. In the emergency steering mode, the fluid flow rate from the hydro-mechanical steering unit 6 remains at its maximum value Qorbmax and is sufficient to provide an emergency steering function in either of the tractor ranges.

Graph 61 illustrates the volume fluid flow Qs1 provided by the steering supply valve arrangement 26 in the first range of tractors and the graph 62 illustrates the overall volume fluid flow Qsum1, provided to the steering actuator 11 in the first range of tractors, this being the sum of the fluid flow Qorb 58 from the hydro-mechanical steering unit and the fluid flow Qs 61 from the steering supply valve arrangement 26. On the left of FIG. 2 it can be seen that the supply valve arrangement 26 begins to supply fluid to the steering actuator during the dead band range of movement of the steering wheel 2 as will be described in more detail later. Within the dead band region, the graph 62 follows graph 61. Following the dead band region and once the hydro-mechanical steering unit 6 begins to supply fluid to the steering actuator 11, the overall fluid flow Qsum1 provided to the steering actuator indicated by graph 62 is increased by the additional flow Qorb 58 from the hydro-mechanical steering unit 6. As illustrated, the supply of fluid Qs from the steering supply valve arrangement 26 is regulated by the controller 21 to enable the overall fluid flow Qsum1 provided to the steering actuator 11, as indicated by graph 62, to be raised up to the first threshold value 50 for the first range of tractors. In an emergency steering condition (indicated schematically in FIG. 2), the fluid flow Qs provided by the steering supply valve arrangement 26 is lost so that graph 61 falls to zero but the overall fluid flow rate Qsum1 provided to the steering actuator as indicated by graph 62 only falls to the maximum flow rate Qorbmax provided by the hydro-mechanical steering unit so that emergency steering function is maintained.

Graph 64 illustrates the volume fluid flow Qs provided by the steering supply valve arrangement 26 for the second range of tractors and graph 66 illustrates the overall volume fluid flow Qsum2 provided to the steering actuator 11 in the second range of tractors, which is the sum of the fluid flow 58 from the hydro-mechanical steering unit 6 and the fluid flow 64 from the steering supply valve arrangement 26. Graphs 64 and 66 follow a similar pattern to graphs 61 and 62 as discussed above and so will not be described again in detail except to note that for the second range of tractors, the steering supply valve arrangement 26 is regulated by the controller 21 to enable the overall fluid flow provided to the steering actuator, as indicated by graph 66, to be raised only up to the lower first threshold value 54 for the second range of tractors under normal operating conditions.

It will be appreciated that FIG. 2 is intended to provide a schematic illustration of the principles of this aspect of the invention and that it does not represent the actual flow of fluid from a hydro-mechanical steering unit 6 and/or a steering supply valve arrangement 26 during a steering manoeuvre.

As noted above, the person skilled in the art will be able to determine appropriate values for the maximum operating volume flow rate Qop and the minimum emergency steering volume flow rate Qe for any given vehicle application and so determine a suitable hydro-mechanical steering unit 26 and steering supply valve arrangement 26 to meet these requirements. Nevertheless, for guidance, the following non-binding examples are provided:

### EXAMPLE 1

A steering system has a first threshold value for the maximum operating volume flow rate Qop of 18 l/min and a second threshold value for the minimum emergency steering volume flow rate Qe of around 6 l/m. The steering system uses a hydro-mechanical steering unit having a maximum flow rate Qorbmax of about 11.25 l/min. This might be achieved using a 250 cm³ (ccm) hydro-mechanical steering unit, for example. In this example, the hydro-mechanical steering unit 6 is able to meet the second threshold value for the minimum emergency steering volume flow rate Qe to provide emergency steering functionality. For use during normal operating conditions, the steering supply valve arrangement 26 is capable of providing a volume fluid flow rate of up to at least 6.75 l/min to enable the system to meet the required maximum operating volume flow rate Qop of 18 l/min.

### EXAMPLE 2

A steering system has a first threshold value for the maximum operating volume flow rate Qop of 22.5 l/min and a second threshold value for the minimum emergency steering volume flow rate Qe of around 8.5 l/m. The steering system uses the same hydro-mechanical steering unit as in example 1, having a maximum flow rate Qorbmax of about 11.25 l/min. In this example, the hydro-mechanical steering unit 6 is still able to meet the second threshold value for the minimum emergency steering volume flow rate Qe to provide emergency steering functionality. For use during normal operating conditions, the steering supply valve arrangement 26 is capable of providing a volume fluid flow rate up to at least 11.25 l/min to enable the system to meet the required maximum operating volume flow rate Qop of 22.5 l/min.

The above examples are for illustration purposes only.

In embodiments, the hydro-mechanical steering unit 6 may have a maximum flow rate Qorbmax which is no more than 40%, or no more than 50%, or no more than 60%, or no more than 70%, or no more than 80%, or no more than 90% of the first threshold value for the maximum operating volume flow rate Qop. However, in particular embodiments, the hydro-mechanical steering unit 6 may have a maximum flow rate Qorbmax which is no more than 50%, or no more than 60%, or no more than 70% of the first threshold value for the maximum operating volume flow rate Qop.

Using the steering supply valve arrangement 26 to amplify the output of the hydro-mechanical steering unit 6 to meet the maximum operating volume flow rate Qop requirements of the hydraulic steering actuator 11 under normal operating conditions can be carried out in addition to modifying the fluid flow to actuator 11 to vary the overall steering ratio R of the steering system in the manner of a superimposed steering system.

As noted above, the because the steering supply valve arrangement 26 is able to provide fluid to the working ports 30, 32 and the steering actuator 11 independently of the hydro-mechanical steering unit 6, the controller 21 is able to regulate the steering supply valve arrangement 26 so as to begin supplying fluid to the steering actuator as soon as the steering wheel 2 is turned, before the steering wheel 2 has moved through the dead band range of movement and the hydro-mechanical steering unit 6 beings to supply fluid to the steering actuator. Movement of the steering wheel 2 is sensed by the steering wheel sensor 4 which sends a signal/data to the controller 21 and the controller 21 analyses the steering wheel position signal/data and other data, such as the position for the steered wheels 14, 16 as detected by the wheel angle sensor 18 and the speed of the vehicle as detected by speed sensor 17 and provides a signal to the steering supply valve arrangement 26 to actuate the steering supply valve arrangement 26 in accordance with one or more management programs or algorithms.

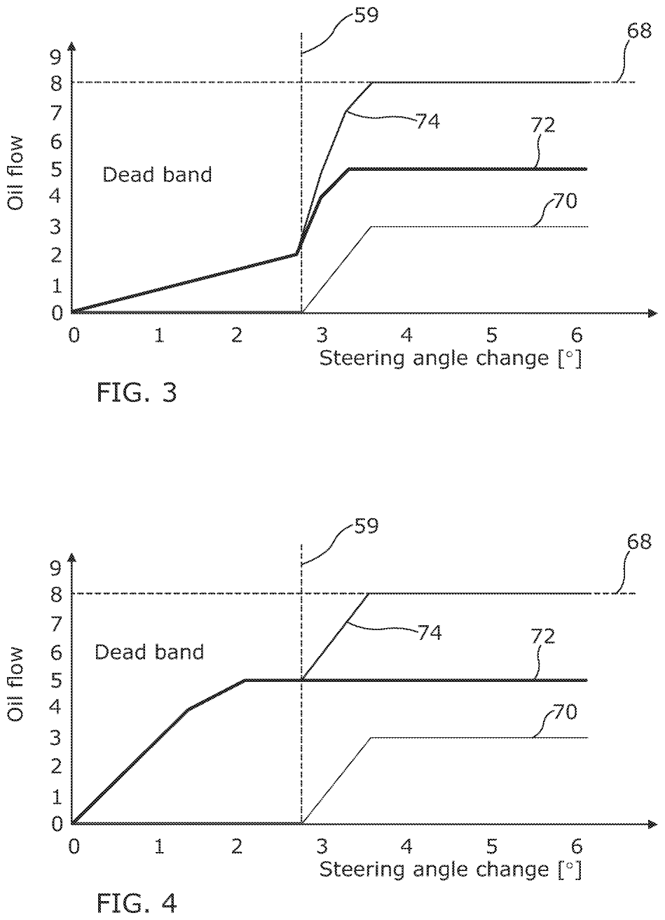

This is shown in FIGS. 3 and 4 which illustrates the flow of fluid from the hydro-mechanical steering unit 6 and the steering supply valve 26 relative to a change in the steering wheel angle during a steering manoeuvre. The horizontal axis indicates the change in steering wheel angle from an initial position O of the steering wheel 2. Broken line 59 indicates an end of a dead band range of movement of the steering wheel 2 and broken line 68 indicates the threshold 1 for the maximum operating volume flow rate Qop. Graph 70 indicates the volume fluid flow rate Qorb provided by the hydro-mechanical steering unit 6. Graph 72 indicates the volume fluid flow rate Qs provided by steering supply valve arrangement 26. Graph 74 indicates the overall volume fluid flow rate Qsum provided through the working port 30, 32 to the steering actuator 11, this being the combination of the fluid flow 70 provided by the hydro-mechanical steering unit 6 and the fluid flow 72 provided by the steering supply valve arrangement 26. When movement of the steering wheel 2 is detected by the steering wheel sensor 4, the controller 21 is operative in response to control actuation of the supply valve arrangement 26 to commence delivery of fluid Qs to the steering actuator 11 immediately so that the steering system 1 reacts to movement of the steering wheel 2 to begin turning the steered wheels 14, 16 without the usual delay caused by the dead band. This provides a faster reaction to the steering demand which is more similar to that of a mechanical steering system such as is found in a conventional automotive vehicle, such as a motor car. Continued movement of the steering wheel 2 beyond the dead band range results in the hydro-mechanical steering unit 6 also supplying fluid Qorb to the steering actuator 11. In this embodiment, the controller 21 continues to actuate the steering supply valve arrangement 26 beyond the dead band range so that the volume flow rate of fluid provided to the steering actuator Qsum (graph 74) is the sum of the volume flow rate Qorb from the hydro-mechanical steering unit 6 (graph 70) and the volume flow rate Qs from steering supply valve arrangement 26 (graph 72). As illustrated, the controller 21 regulates the fluid flow from the steering supply valve arrangement 26 so that the volume flow rate of fluid Qsum provided to the steering actuator 11 is increased up to the maximum operating volume flow rate Qop (threshold 1-line 68) as required by the steering system for effective steering control under normal operating conditions.

FIGS. 3 and 4 illustrate how the steering supply valve arrangement 26 can be controlled to provide different steering profiles. In FIG. 3, the steering supply valve arrangement 26 is actuated to provide a gradual increase in the volume flow rate of fluid Qs provided to the steering actuator 11 across the dead band range, the fluid flow from the steering supply valve arrangement 26 being ramped up to the level required to meet the maximum operating volume flow rates Qop (threshold 1) only after the steering wheel 2 has moved beyond the dead band range of movement. In contrast, FIG. 4 illustrates the steering supply valve arrangement 26 being actuated to provide a more rapid initial increase in the fluid flow rate Qs to the steering actuator 11 reaching the level of fluid flow from the steering supply valve arrangement 26 within the dead band range of movement of the steering wheel that is required to subsequently meet the maximum operating volume flow rates Qop (threshold 1) once the fluid supply from the hydro-mechanical steering unit 6 reaches its maximum. The control strategy illustrated in FIG. 3 will provided a relatively slow steering response to a small initial movement of the steering wheel 2. This may be appropriate for use of a vehicle at speed on a road. The control strategy illustrated in FIG. 4, will provide a faster steering response to a small initial movement of the steering wheel 2. This may be appropriate for a vehicle, such as a tractor, operating at slow speeds in an off-road environment where increased manoeuvrability can be provided without compromising safety. The controller 21 may take into account data such as vehicle speed v and/or steered wheel position to determine an appropriate control strategy to apply in response to a steering wheel movement. Suitable management programs and/or algorithms may be saved in the memory 23 or be otherwise available to the controller 21.

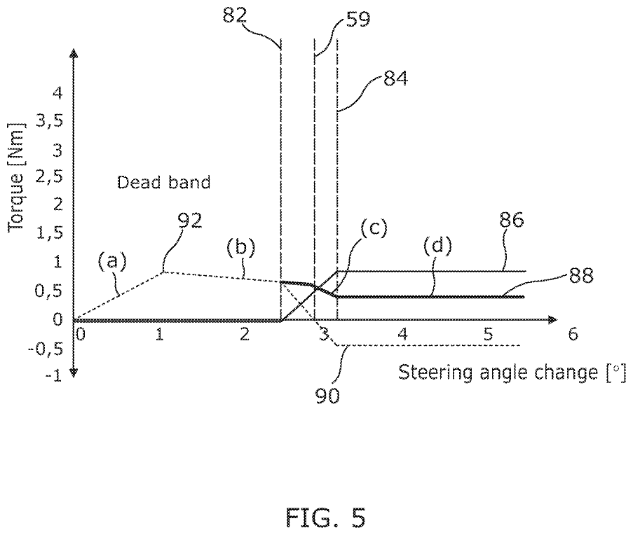

A potential issue of using the steering supply valve arrangement 26 to begin supplying fluid to actuate the steering actuator 11 within the dead band region is that the steering system 1 does not inherently provide much resistance to the steering wheel 2 being turned in this range of steering wheel movement. The steering in the dead band range will feel very light to a user and so is not natural, especially to a user who is familiar with non-hydraulic steering systems as used in most automotive vehicles, such as motor cars. To address this issue, and in accordance with a further aspect of the invention, the controller 21 is configured to actuate the motor 5 to apply a torque to the steering shaft 3 to produce an appropriate haptic steering torque feedback to a user turning the steering wheel 2. This is illustrated in FIG. 5.

FIG. 5 illustrates the torque which opposes rotation of the steering wheel 2 from an initial position 0 during a steering manoeuvre and which the user will feel as a resistance to the steering wheel movement. As noted previously, the initial position is a start position of the steering wheel 2 prior to it being rotated and is not necessarily a neutral or straight ahead position of the steered wheels 14, 16 or the steering wheel 2. It can be any angular position. This torque gives rise to the feel of the steering and can be described as a haptic steering torque feedback. The end of the dead band range of movement of the steering wheel from the initial position is indicted by line 59. The beginning of the transitional range of movement in which the hydro-mechanical steering unit spring 40 begins to apply a reactive torque to the steering wheel shaft 3 which opposes the torque applied by the user through the steering wheel 2 is indicated by line 82 and the end of the transitional range of movement at which the torque applied by the hydro-mechanical steering unit spring is at its maximum is indicated by line 84.

The torque which a user must apply to the steering wheel to overcome the resistance in the steering system itself (i.e. if the electric motor 5 is not used to apply a torque to the steering shaft 3) is indicated by graph 86. During an initial range of movement of the steering wheel 2 within the dead band up to the beginning the transitional range 82, the steering system 1 provides very little resistance to the steering wheel 2 being turned. Thus the steering will feel very light, which may not feel natural give that the steering supply valve arrangement 26 is operative to turn the steered wheels 14, 16 in this range of movement.

During the transitional range of movement (between lines 82 and 84), the hydro-mechanical steering unit spring 40 will apply an increasing reactive torque to the steering shaft 3 which opposes the torque applied to the user. As shown, the reactive torque applied by the hydro-mechanical steering unit spring 40 rises quite rapidly in the transitional range, so that the user will experience a sudden rise in the weight of the steering. This feels very unnatural, especially to someone not used to driving a vehicle with this type of steering system. By the end of the transitional range (line 84) the torque applied by the hydro-mechanical steering unit spring 40 is at its maximum. In this embodiment, the transitional range ends outside the dead band range and so by this stage the hydro-mechanical steering unit will be supplying fluid to the hydraulic steering actuator which may add to the resistance felt by the user in turning the steering wheel 2. Following the end of the transitional range 84 and for as long as the user continues to move the steering wheel, the hydro-mechanical steering unit spring applies a substantially constant reactive torque to the steering shaft 3 opposing the torque applied by the user to the steering wheel. During this continued rotational movement of the steering wheel 2, the steering will feel relatively heavy.

The haptic steering torque profile which would be felt by the user at the steering wheel 2 which is inherently generated by the steering system, especially the hydro-mechanical steering unit, is very different to the torque profile which would be felt at the steering wheel of a conventional mechanical automotive steering system as used in a typical motor car. Such a conventional steering system will generally provide a resistance to turning the steering wheel which increases rapidly on first movement of the steering wheel, before gradually reducing as the user continues to rotate the steering wheel. This is mainly caused by the mechanical friction and mechanical resistance in mechanical steering systems. In accordance with this aspect of the invention, the controller 21 is configured to modulate the magnitude and direction of torque applied by the electric motor 5 to the steering shaft 3 so that the user feels a haptic steering torque feedback which follows a predetermined profile. The profile may be configured to replicate more closely the feel of steering in a motor car or other vehicle with a mechanical steering system, including fluid power assisted mechanical steering systems.

In FIG. 5, graph 88 illustrates an embodiment of a desired haptic steering torque feedback profile which is to be provided to a user at the steering wheel 2 and graph 90 illustrates a torque profile applied by the motor 5 to the steering shaft 3 to achieve the desired haptic steering torque feedback profile 88. During movement of the steering wheel 2 up to the start of the transitional range 82, the torque profile 90 applied by the motor 5 to the steering shaft 3 provides substantially the only resistance to turning the steering wheel 2 felt by the user and so in this range of movement of the steering wheel, graphs 88 and 90 follow the same path.

As illustrated in FIG. 5, a desired haptic steering torque feedback profile 88 may include a fairly steep increase (a) in torque opposing the torque applied by the user to the steering wheel which reaches a peak 92 after a relatively small change in the steering wheel angle at a position intermediate the initial position 0 of the steering wheel and the end of the dead band range 59. As the steering wheel 2 is turned further, the desired haptic steering torque feedback profile 88 includes a gradual reduction (b) in the torque opposing the torque applied by the user to the steering wheel up to the end of the dead band range 59. After the dead band range, the desired haptic steering torque feedback profile 88 includes slightly steeper reduction in the torque opposing the torque applied by the user up to the end of the transitional range 84 as indicated at (c). Thereafter, the desired haptic steering torque feedback profile 88 includes a substantially constant torque (d) opposing the torque applied by the user to the steering wheel 2 but at a level which is lower than the torque applied by the hydro-mechanical steering unit spring 40 in this range of movement of the steering wheel 2.

To produce the desired haptic steering torque feedback profile 88, the controller 21 is configured to actuate the motor 5 as appropriate in order to generate the torque profile according to graph 90. On initial movement for the steering 2 from the initial position 0 up to the beginning of the transitional range 82, the controller 21 regulates the motor to apply a torque to the steering shaft 3 in the opposite direction to the torque applied by the user to the steering shaft via the steering wheel 2. The level of the torque applied by the motor 5 is varied in line with the desired haptic steering torque feedback profile 88 for this range of movement of the steering wheel 2. Thus the motor 5 is actuated to apply a fairly rapidly increasing torque (a) to the steering shaft 3 following initial movement of the steering wheel 2, the torque increasing up to a maximum at 92 when the steering wheel is at an intermediate position between the initial position 0 and the end of the dead band range 59. During movement of the steering wheel from this intermediate position 3 until the beginning of the transitional range 82, the torque applied by the motor 5 to the steering shaft is gradually reduced following the desired haptic steering torque feedback profile 88 profile (b). During the transitional range, the hydro-mechanical steering unit spring 40 begins applying a reactive torque to the steering shaft 3 opposing the torque applied by the user through the steering wheel. This reactive torque increases rapidly through the transitional range before reaching a maximum value at the end of the transitional range 84. Once the hydro-mechanical steering unit spring 40 is activated, the torque felt by a user at the steering wheel 2 is the sum of the torques applied to the steering shaft 3 applied by the hydro-mechanical steering unit spring 40 and the electric motor 5. To maintain the desired haptic steering torque feedback profile 88, the controller 21 regulates the electric motor 5 such that the torque applied by the motor 5 to the steering shaft 3 compensates for the reactive torque applied by the hydro-mechanical steering unit spring 40. As the reactive torque applied by the hydro-mechanical steering unit spring 40 increases in the transitional range, the torque applied by the electric motor 5 is initially maintained in the same direction opposing the torque applied by the user but is reduced in dependence on the increase in the reactive toque from the hydro-mechanical steering unit spring 40. At some point as the reactive torque applied by the hydro-mechanical steering unit spring 40 increases, the torque applied by the electric motor 5 is reduced to zero and the motor subsequently actuated to apply a torque to the steering shaft which rotates the steering shaft 3 in the same direction as the user, so as to assist the user in overcoming the torque applied by the hydro-mechanical steering unit spring 40. In the present embodiment, the torque applied by the electric motor 5 is reduced to zero at or near the end of the dead band range as indicated by line 59. Thereafter, the direction of the motor 5 is reversed to apply a torque to the steering shaft 3 in the same direction as the user, thus opposing the reactive torque applied by the hydro-mechanical steering unit spring 40. The torque applied by the motor 5 to the steering shaft 3 assisting the user is increased through the remainder of the transitional range. Once the transitional range has ended 84 and the hydro-mechanical steering unit spring 40 is providing its maximum reactive torque, the torque applied by the electric motor 5 to assist the user is kept substantially constant. As a result, the user feels a haptic steering torque feedback 88 which remains substantially constant for further movement of the steering wheel 2 but at a level which is lower than the reactive torque of the hydro-mechanical steering unit spring 40.

It will be appreciated that the desired haptic steering torque feedback profile 88 can be varied from that shown in FIG. 5 and described above. It will also be appreciated that the electric motor 5 can be controlled to apply a torque to the steering shaft 3 which is also varied in magnitude and/or direction to take into account other effects of the steering system as the steering wheel 2 is rotated during a steering manoeuvre.

Furthermore, the actual values of the torque applied in a desired haptic steering torque feedback profile 88 can also vary from those as shown in FIG. 5. The controller 21 may be configured to alter the desired haptic steering torque feedback profile 88 or to select from a range of different desired haptic steering torque feedback profiles in dependence on one or more operating parameters of the vehicle. For example, the controller 21 may be configured to regulate actuation of the electric motor 5 such that the user is subject to higher levels of torque opposing movement of the steering wheel 2 when the vehicle is traveling at relatively high speeds, say on a road. This results in higher safety, stability and controllability when operating at higher speeds. In contrast, lower levels of haptic steering torque feedback may be desirable if the vehicle is operating in an off-road situation at low speeds. For example, this may be desirable for an agricultural tractor operating off-road to increase manoeuvrability and to reduce user fatigue when carrying out repeated large steering manoeuvres. The controller 21 may adopt a desired haptic steering torque feedback profile 88 and/or control of the electric motor 5 in response to one or more parameters indicative of an operating state of the vehicle. These may include any one or more of the following:
a. a steering angle of the steered wheel;
b. a steering angle of the steering member;
c. a steering torque applied by a user to the steering member;
d. a ground speed of the vehicle;
e. fluid pressure differential between the chambers of the steering actuator;
f. speed of movement of the steering wheel.

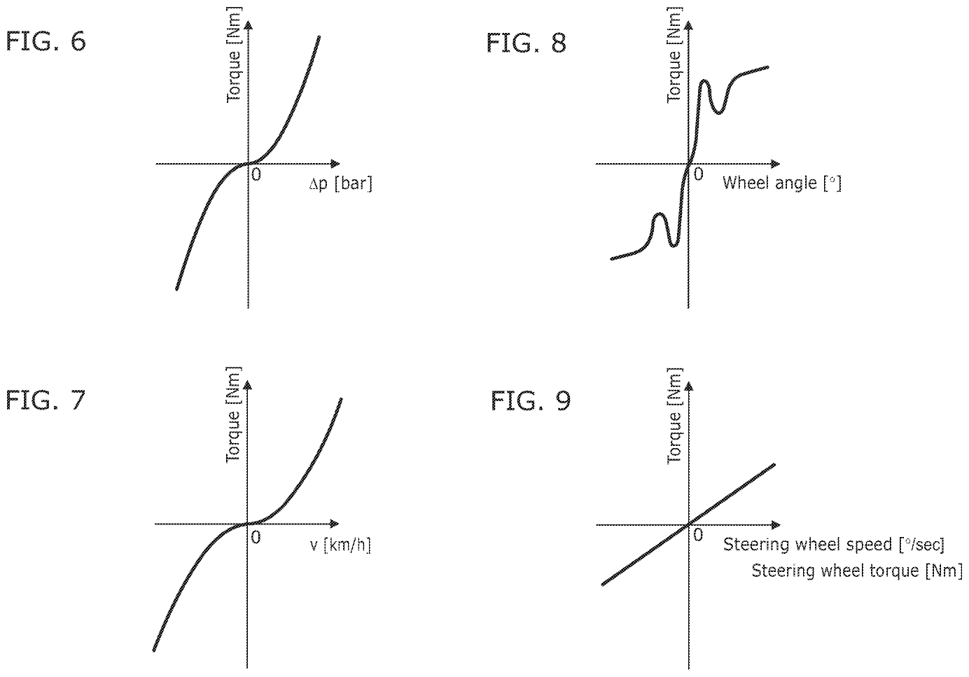

FIGS. 6, 7, 8 and 9 illustrate how a desired feedback torque at the steering wheel 2 might be varied in dependence changes in various parameters.

FIG. 6 illustrates that the haptic steering torque feedback can be varied as a function the pressure differential between the first and second chambers 34, 36 in the steering actuator so that the torque increases with an increase in the pressure differentia Δp. The relationship may be linear/logarithmic/parabolic. This simulates a user reaction force should the pressure differential increase, say when driving over a large stone in a field for example.

FIG. 7 illustrates that the haptic steering torque feedback can be increased as the speed v of the vehicle increases. Generally it is desirable to increase resistance to steering as the speed of a vehicle increases. This results in higher safety, stability and controllability at higher speeds. In this regard, following the transitional range when the hydro-mechanical steering unit spring 40 is generating a maximum reactive torque resisting the steering movement of a user and the electric motor 5 is used to assist the user, the torque applied by the motor 5 may be reduced to increase the haptic steering torque feedback. It is also possible that the electric motor 5 could be reversed in this phase so as to add further resistance to the steering motion if the reactive torque from the hydro-mechanical steering unit spring is not sufficient.

FIG. 8 illustrates how the haptic steering torque feedback torque created using the electric motor may be varied in response to movement of the steered wheels 14, 16. Here it should be noted that the 0 position is not necessarily a straight ahead position but is any initial positon of the steered wheels when the steering wheel 2 is moved. Whenever the steering wheel 2 is moved to generate a new steering demand, the steering system always has to go through a dead band range to the left or the right. Within this dead band the electric motor 5 can be used to provide an initial high torque resistance to movement of the steering wheel 2, otherwise the steering wheel 2 would feel very floppy in the very first 1-3° or so of steering. After steering through the dead band range, the haptic steering torque feedback torque may be reduced so that the steering wheel becomes a bit easier to move and to allow the steering movement to be continued. However, the haptic steering torque feedback should not be too low and it may be desirable to provide a substantially constant resistance to movement of the steering wheel after the dead band similar to an automotive steering system. This can be achieved by using constant torque applied by the electric motor 5 to partially balance the reactive steering force generated by the hydro-mechanical steering unit spring 40.

FIG. 9 illustrates how the haptic steering torque feedback torque can be varied in dependence on the speed of movement of the steering wheel 2 and/or in dependence on the torque applied by a user to the steering wheel. Generally speaking it is desirable to increase the resistance to the steering wheel 2 being rotated as the speed at which steering wheel is moved by a user is increased or where the torque applied to the steering wheel 2 by a user is increased. Alternatively, depending on the situation, instead of applying a resistance torque using the electric motor 5, the motor could be used to support steering wheel movement and hence the user by applying torque in the same direction as the user. This could be beneficial when a tractor is in standstill position (zero ground vehicle speed) and the driver has the desire to move the steering wheel as fast as possible from left to right due to specific field work applications. Accordingly, the controller 21 may be configured to use several different parameters to determine an appropriate haptic steering torque feedback profile to apply.

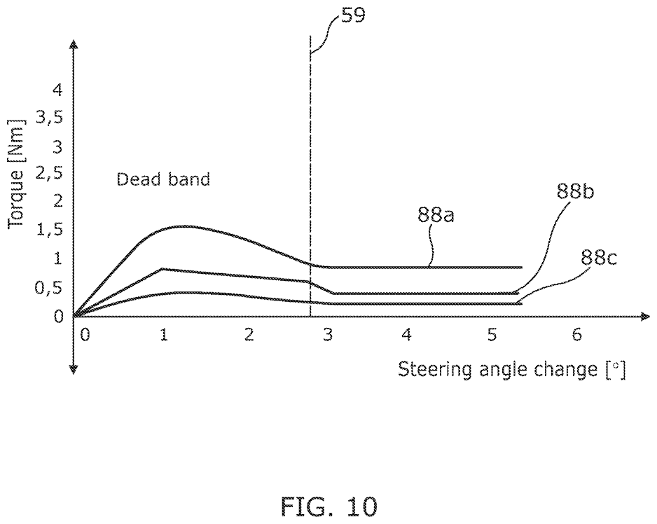

FIG. 10 illustrates modified haptic steering torque feedback profiles 88a, 88b, 88c which may be adapted using the principles outlined above. It will be noted that whilst these various profiles 88a, 88b, 88c vary in the actual torque levels applied at the steering wheel, the overall shape of the profiles remains largely similar, with a rapid increase in the haptic steering torque feedback during an initial movement of the steering wheel 2 and the haptic steering torque feedback then gradually reduced to a lower and substantially constant torque outside of the dead band range.

This aspect of the invention not only allows the haptic steering torque feedback profile to be tailored to provide an improved driving experience, it can also be used to deliver a similar steering feel across a range of vehicles of differing sizes.

This aspect of the invention in providing a desired haptic steering torque feedback profile 88 can be applied independently of the first aspect of the invention. That is to say, the teaching above in relation to haptic steering torque feedback can be applied in a steering system in which the hydro-mechanical steering unit 6 is capable of delivering a maximum flow rate Qorbmax which is able to at least meet the maximum operating volume flow rate Qop (threshold 1) of the system. In such an embodiment, the steering supply valve arrangement 26 may be used to supply fluid to the steering actuator 11 only during the dead band range of movement of the steering wheel 2. In particular, the concept of using the electric motor 5 to provide a haptic steering torque feedback during the dead band range would be particularly beneficial in this case.

The steering systems 1 and methods of control described above are particularly, but not exclusively, suitable for use in a utility vehicle, including agricultural vehicles such as agricultural tractors and the like.

All references cited herein are incorporated herein in their entireties. If there is a conflict between definitions herein and in an incorporated reference, the definition herein shall control.

1. An electro-hydraulic steering system for a vehicle comprising:
a hydraulic steering actuator for turning a steered wheel through a rotation angle;
a fluid supply arrangement including a source of pressurized fluid and a tank;
a working port arrangement having two working ports fluidly connected with the hydraulic steering actuator;
a hydro-mechanical steering unit fluidly connected between the fluid supply arrangement and the working port arrangement and configured to connect one of the working ports with the source of pressurized fluid and the other with the tank in dependence on a steering demand;
a steering member connected with the hydro-mechanical steering unit by a steering shaft, the steering member movable by a user to rotate the steering shaft to generate a steering demand;
a steering member sensor connected to a controller to detect the position and/or movement of the steering member;
an electric motor operative to apply a torque to rotate the steering shaft when actuated to provide a haptic steering torque feedback to a user through the steering member, the electric motor operatively connected to the controller;
wherein the controller is configured modify a haptic steering torque feedback sensed by the user through the steering member by providing a control output to control actuation of the electric motor to apply torque to rotate the steering shaft, wherein the controller is configured to control actuation of the electric motor in dependence on at least one parameter indicative of an operating condition of the vehicle such that the haptic steering torque feedback sensed by the user follows a predetermined profile over a range of movement of the steering member from an initial position.

2. An electro-hydraulic steering system as claimed in claim 1, wherein controller is configured to control actuation of the electric motor to modify the haptic steering torque feedback sensed by the user in dependence on at least one of the following:
a. a steering angle of the steered wheel;
b. a steering angle of the steering member;
c. a steering torque applied by a user to the steering member;
d. a ground speed of the vehicle;
e. fluid pressure differential between the chambers of the steering actuator;
f. speed of movement of the steering member.

3. An electro-hydraulic steering system as claimed in claim 1, wherein the controller is configured such that when the steering member is moved from an initial position through at least part of a dead band range of movement of the steering member in which the hydro-mechanical steering unit does not supply fluid to said one working port, the controller actuates the electric motor to apply a torque to rotate the steering shaft in a direction which opposes the direction of rotation applied to the steering shaft by the user.

4. An electro-hydraulic steering system as claimed in claim 3, wherein the controller is configured to actuate the electric motor to apply an increasing level of torque rotating the steering shaft in a direction which opposes the direction of rotation applied by the user through the steering member during a first phase of movement of the steering member from an initial position to an intermediate position between the initial position and the end of the dead band range of movement and to apply a decreasing level of torque rotating the steering shaft in the same direction during a second phase of the movement of the steering member beyond the intermediate position within the dead band range of movement.

5. An electro-hydraulic steering system as claimed in claim 1, wherein the hydro-mechanical steering unit comprises a resilient biasing arrangement which biases the unit to a neutral position in which no fluid is supplied to the working port arrangement, the hydro-mechanical steering unit being movable to a first working position in which a first of the working ports is connected with the pressurized fluid supply and a second of the working ports is connected with the tank in response to a movement of the steering member from an initial position in a first rotary direction and movable to a second working position in which the first of the working ports is connected with the tank and the second of the working ports is connected with the source of pressurized fluid in response to a movement of the steering member from an initial position in a second rotary direction opposite to the first, the resilient biasing arrangement generating a torque on the steering shaft which opposes the direction of rotation of the steering member applied by the user when the hydro-mechanical steering unit is moved from the neutral position to either of the first and second working positions, wherein the resilient biasing arrangement generates substantially no torque during a first range of movement of the steering member from an initial position, the resilient biasing arrangement generating an increasing level of torque on the steering shaft during a transitional range of rotational movement of the steering member following the first range of movement, and the resilient biasing arrangement generating a substantially steady level of torque during movement of the steering member beyond the transitional range; wherein the controller is configured to control actuation of the motor so that during the transitional range of movement of the steering member, the torque applied by the electric motor to rotate the steering shaft in a direction which opposes the rotational movement of the steering member by the user is reduced as a function of the increasing torque applied to the steering shaft by the resilient biasing arrangement.

6. An electro-hydraulic steering system as claimed in claim 1, wherein the controller is configured to control actuation of the electric motor so as to modulate the degree and direction of the torque applied by the electric motor to the steering shaft as the steering member is moved from an initial position during a steering manoeuvre as to maintain the predefined profile of haptic steering torque feedback compensating for any torque applied to the steering shaft resulting from operation of the hydro-mechanical steering unit, including for example torque applied to the steering shaft by a resilient biasing arrangement of the hydro-mechanical steering unit.

7. A vehicle comprising electro-hydraulic steering system according to claim 1, wherein optionally, the vehicle is a utility vehicle such as an agricultural tractor or a self-propelled mobile machine.

8. A method of operating an electro-hydraulic steering system for a vehicle, the system comprising a hydraulic steering actuator and a hydro-mechanical steering unit for actuating the hydraulic steering actuator in response to a steering demand from a steering member connected to the hydro-mechanical steering unit by a steering shaft, the system including an electric motor for applying a torque to the steering shaft to provide a haptic steering torque feedback to a user through the steering member, and an electronic controller for controlling actuation of the electric motor; the method comprising controlling actuation of the electric motor to provide a haptic steering torque feedback sensed by the user in dependence on at least one parameter indicative of an operating condition of the vehicle such that the haptic steering torque feedback sensed by the user follows a predetermined profile over a range of movement of the steering member from an initial position.

9. A method of operating an electro-hydraulic steering system for a vehicle, the system comprising:
a hydraulic steering actuator for turning a steered wheel through a rotation angle;
a fluid supply arrangement including a source of pressurized fluid and a tank;
a working port arrangement having two working ports fluidly connected with the hydraulic steering actuator;
a hydro-mechanical steering unit fluidly connected between the fluid supply arrangement and the working port arrangement and configured to connect one of the working ports with the source of pressurized fluid and the other with the tank in dependence on a steering demand;
a steering member connected with the hydro-mechanical steering unit by a steering shaft, the steering member movable by a user to rotate the steering shaft to generate a steering demand;
a steering member sensor connected to a controller to detect the position and/or movement of the steering member;
an electric motor operative to apply a torque to rotate the steering shaft when actuated to provide a haptic steering torque feedback to a user through the steering member, the electric motor operatively connected to the controller;
the method comprising modifying a haptic steering torque feedback sensed by the user through the steering member by actuating the electric motor to apply torque to rotate the steering shaft, actuation of the electric motor being carried out in dependence on at least one parameter indicative of an operating condition of the vehicle such that the haptic steering torque feedback sensed by the user follows a predetermined profile over a range of movement of the steering member from an initial position.

10. A method as claimed in claim 8, the method comprising controlling the electric motor to modify the haptic steering torque feedback sensed by the user in dependence on at least one of the following:
a steering angle of the steered wheel;
a steering angle of the steering member;
a steering torque applied by a user to the steering member;
a ground speed of the vehicle;
fluid pressure differential between the chambers of the steering actuator;
speed of movement of the steering member.

11. A method as claimed in claim 8, the method comprising controlling actuation of the electric motor to apply a torque to rotate the steering shaft in a direction which opposes the direction of rotation applied to the steering shaft by the user when the steering member is moved from an initial position through at least part of a dead band range of movement in which the hydro-mechanical steering unit does not supply fluid to said one working port.

12. A method as claimed in claim 8, the method comprising controlling actuation of the electric motor to apply an increasing level of torque rotating the steering shaft in a direction which opposes the direction of rotation applied by the user through the steering member during a first phase of movement of the steering member from an initial position to an intermediate position between the initial position and the end of the dead band range of movement and to apply a decreasing level of torque rotating the steering shaft in the same direction during a second phase of the movement of the steering member beyond the intermediate position within the dead band range of movement.

13. A method as claimed in claim 8, wherein the hydro-mechanical steering unit comprises a resilient biasing arrangement which biases the unit to a neutral position in which no fluid is supplied to the working port arrangement, the hydro-mechanical steering unit being movable to a first working position in which a first of the working ports is connected with the pressurized fluid supply and a second of the working ports is connected with the tank in response to movement of the steering member from an initial position in a first rotary direction and is movable to a second working position in which the first of the working ports is connected with the tank and the second of the working ports is connected with the source of pressurized fluid in response to movement of the steering member from an initial position in a second rotary direction opposite to the first, the resilient biasing arrangement generating a torque on the steering shaft which opposes the direction of rotation of the steering member applied by the user when the hydro-mechanical steering unit is moved from the neutral position to either of the first and second working positions, wherein the resilient biasing arrangement generates substantially no torque during a first range of movement of the steering member from the initial position, the resilient biasing arrangement generating an increasing level of torque on the steering shaft during a transitional range of rotational movement of the steering member following the first range of movement, and the resilient biasing arrangement generating a substantially steady level of torque during movement of the steering member beyond the transitional range; wherein the method comprises controlling actuation of the electric motor so that during the transitional range of movement of the steering member, the torque applied by the electric motor to rotate the steering shaft in a direction which opposes the rotational movement of the steering member by the user is reduced as a function of the increasing torque applied to the steering shaft by the resilient biasing arrangement.

14. A method as claimed in claim 8 the method comprising controlling actuation of the electric motor so as to modulate the degree and direction of the torque applied by the electric motor to the steering shaft as the steering member is moved from an initial position during a steering manoeuvre as to maintain the predefined profile of haptic steering torque feedback compensating for any torque applied to the steering shaft resulting from operation of the hydro-mechanical steering unit, including for example torque applied to the steering shaft by a resilient biasing arrangement of the hydro-mechanical steering unit.
